(19) United States
(12) Patent Application Publication
(10) Pub. No.: US 2010/0062400 A1
(43) Pub. Date: Mar. 11, 2010

(54) Method of Operating a Drive Simulator

(75) Inventors: Kevin Streck, Seven Hills, OH (US); Julie Edgar, Concord Township, OH (US); Christopher Prengaman, Painesville, OH (US); Robert C. Richardson, Andover, KS (US)

Correspondence Address: THE LUBRIZOL CORPORATION;ATTN: DOCKET CLERK, PATENT DEPT., 29400 LAKELAND BLVD., WICKLIFFE, OH, 44092, US

(73) Assignee: The Lubrizol Corporation, Wickliffe, OH (US)

(21) Appl. No.: 12/552,539

(22) Filed: Sep. 2, 2009

Related U.S. Application Data
(60) Provisional application No. 61/094,435, filed on Sep. 5, 2008.

(51) Int. Cl. G09B 9/02

(52) U.S. Cl. 434/29

(57) ABSTRACT

The disclosed invention relates to a method of operating a drive simulator to simulate the driving of a vehicle when the transmission or axle is improperly lubricated. The drive simulator may be used to simulate chatter, shudder or shift feel.

This application claims priority from U.S. Provisional Application 61/094,435, filed Sep. 5, 2008

### TECHNICAL FIELD

This invention relates to a method of operating a drive simulator to simulate the driving of a vehicle when the transmission or axle of the vehicle is improperly lubricated.

### BACKGROUND

Driving events such as shudder, chatter and shift feel typically result when the transmission or axle of a vehicle is improperly lubricated. These events are often difficult to demonstrate. The problem therefore is to provide a teaching tool that can be used to demonstrate these driving events in order to accurately address the problem of providing proper lubrication. This invention provides a solution to this problem.

### SUMMARY

This invention relates to a method for demonstrating driving events that occur when the transmissions or axles of vehicles are improperly lubricated. These driving events include shudder, shift feel and chatter. The inventive method, which involves the use of a drive simulator, may be used as an educational or marketing tool to show customers and end users what the driver of a vehicle will experience when these driving events occur. The inventive method may be used for diagnostic purposes wherein a vehicle exhibiting shudder, shift feel or chatter problems is test driven and then the inventive method is used to simulate those problems and as a result identify the lubrication problem.

This invention relates to a method of operating a drive simulator, the drive simulator comprising: a sled mounted on a support base, the sled being capable of pitching forward and backward and rolling left and right; a first motor mounted on the support base and connected to the sled; a second motor mounted on the support base and connected to the sled; a steering wheel; a first foot pedal; a second pedal; a computer and a visual display unit for displaying images generated by the computer, the images providing a simulated driving experience; the steering wheel, first foot pedal and second foot pedal being electronically connected to the first motor and to the second motor and adapted for controlling the images, the method comprising: depressing the first foot pedal, the depressing of the first foot pedal causing the first motor to rotate in a first direction and the second motor to rotate in a second direction, the second direction being opposite the first direction, the rotation of the first motor in the first direction and the rotation of the second motor in the second direction causing backward pitching of the sled, and the depressing of the first foot pedal causing the image of an accelerating vehicle to appear on the visual display unit; depressing the second foot pedal, the depressing of the second foot pedal causing the first motor to rotate in the second direction and the second motor to rotate on the first direction, the rotation of the first motor in the second direction and the rotation of the second motor in the first direction causing a forward pitching of the sled, and the depressing of the second foot pedal causing the image of a braking vehicle to appear on the visual display unit; turning the steering wheel to the left, the turning of the steering wheel causing the first motor to rotate in the second direction and the second motor to rotate in the second direction, the rotation of the first motor in the second direction and the rotation of the second motor in the second direction causing a rolling of the sled to the right, and the turning of the steering wheel causing the image of a vehicle turning left to appear on the visual display unit; turning the steering wheel to the right, the turning of the steering wheel causing the first motor to rotate in the first direction and the second motor to rotate in the first direction, the rotation of the first motor in the first direction and the rotation of the second motor in the first direction causing a rolling of the sled to the left, and the turning of the steering wheel causing the image of a vehicle turning right to appear on the visual display unit; simulating chatter by turning the steering wheel to the left or right causing the sled to roll to the right or to the left, and transmitting an electronic signal to the first motor to oscillate the rotation of the first motor from the first direction to the second direction and transmitting an electronic signal to the second motor to oscillate the rotation of the second motor from the second direction to the first direction to cause the sled to pitch backward and then forward; simulating shudder by transmitting an electronic signal to the first motor to oscillate the rotation of the first motor from the first direction to the second direction and transmitting an electronic signal to the second motor to oscillate the rotation of the second motor from the second direction to the first direction to cause the sled to pitch backward and then forward; and simulating shift feel by transmitting an electronic signal to the first motor to rotate the first motor in the second direction and rotate the second motor in the first direction to cause the sled to pitch forward, then to rotate the first motor in the first direction and rotate the second motor in the second direction to cause the sled to pitch backward.

In one embodiment, the first motor is connected to the sled through a first gear box, a first bell crank and a first pivot arm, the first gear box comprising a plurality of gears; and the second motor is connected to the sled through a second bell crank and a second pivot arm, the second gear box comprising a plurality of gears; the rotation of the first motor in the first direction causing the gears in the first gear box and the first bell crank to rotate in the first direction and a lowering of the first pivot arm, the rotation of the second motor in the second direction causing the gears in the second gear box and the second bell crank to rotate in the second direction and a lowering of the second pivot arm, the lowering of the first pivot arm and the second pivot arm causing backward pitching of the sled; the rotation of the first motor in the second direction causing the gears in the first gear box and the first bell crank to rotate in the second direction and a raising of the first pivot arm, the rotation of the second motor in the first direction causing the gears in the second gear box and the second bell crank to rotate in the first direction and a raising of the second pivot arm, the raising of the first pivot arm and the second pivot arm causing a forward pitching of the sled; the sled rolling to the right by rotating the first motor in the second direction and rotating the second motor in the second direction, the rotation of the first motor in the second direction causing the gears in the first gear box and the first bell crank to rotate in the second direction and a raising of the first pivot arm, the rotation of the second motor in the second direction causing the gears in the second motor and the second bell crank to rotate in the second direction and a lowering of the second pivot arm, the raising of the first pivot arm and the lowering of the second pivot arm causing a rolling of the sled to the right; and the sled rolling to the left by rotating the first motor in the first direction and the second motor in the first direction, the rotation of the first motor in the first direction causing the gears in the first gear box and the first bell crank to rotate in the first direction and a lowering of the first pivot arm, the rotation of the second motor in the first direction causing the gears in the second motor and the second bell crank to rotate in the first direction and a raising of the second pivot arm, the lowering of the first pivot arm and the raising of the second pivot arm causing a rolling of the sled to the left.

### BRIEF DESCRIPTION OF THE DRAWINGS

In the annexed drawings, like parts and features have like designations.

FIG. 1 is schematic illustration of the drive simulator that may be used with the inventive method.

FIG. 2 is a side elevational view of the drive simulator illustrated in FIG. 1 taken from the right side of the simulator.

FIG. 3 is a side elevational view of the drive simulator illustrated in FIG. 1 taken from the left side of the simulator.

FIG. 4 is a side elevational view of the drive simulator illustrated in FIG. 1 taken from the right side of the simulator.

FIG. 5 is an elevational view of the drive simulator illustrated in FIG. 1 taken from the back end of the drive simulator.

FIG. 6 is an elevational view of the simulator illustrated in FIG. 1 taken from the front end of the simulator.

FIG. 7 is an illustration showing the graphics used with the visual display unit provided with the drive simulator illustrated in FIG. 1.

FIG. 8 is a flow chart showing the operation of the motors used with the drive simulator illustrated in FIG. 1 when the simulator is used to demonstrate the operation of a vehicle experiencing chatter or shudder.

FIG. 9 is a flow chart showing the operation of the motors used with the drive simulator illustrated in FIG. 1 when the simulator is used to demonstrate the operation of a vehicle experiencing shift feel.

### DETAILED DESCRIPTION

All ranges and ratio limits disclosed in the specification and claims may be combined in any manner. It is to be understood that unless specifically stated otherwise, references to “a,” “an,” and/or “the” may include one or more than one, and that reference to an item in the singular may also include the item in the plural. All combinations specified in the claims may be combined in any manner.

The term “shift feel” refers to an event that occurs in a vehicle employing an automatic transmission when traveling at a speed in the range from about 40 to about 90 miles per hour while upshifting to any gear. Shift feel may involve a bump or harsh engagement that occurs during upshifting. Shift feel may originate in the transmission and cause excess rocking of the transmission and engine which may transmit to the entire vehicle. Shift feel may be caused by improper frictional characteristics of a fluid or excessively worn fluid in the automatic transmission. This may lead to improper operation of clutches and valves.

The term “chatter” refers to an event that occurs with the rear axle of a vehicle. When chatter occurs, high-frequency vibration may be felt when driving at a low speed (e.g., about 5 to about 30 mph) while turning. The vibration may originate in the rear axle of a vehicle fitted with a limited-slip axle containing clutch plates and be transmitted through the drive shaft to the entire vehicle. Chatter may be caused by improper frictional characteristics of a fluid or excessively worn fluid in the rear axle which may lead to a stick-slip of the clutch plates. Chatter may be accompanied by a whining/moaning noise.

The term “shudder” refers to an event that occurs in a vehicle equipped with an automatic transmission and lock-up converter. Shudder may involve a high-frequency vibration which may be felt when driving at a constant speed in top gear with the lock-up torque converter activated. The vibration may originate in the torque converter and be transmitted to the entire vehicle via the transmission/engine mounts. Shudder may be caused by improper frictional characteristics of a fluid or an excessively worn fluid or water intrusion into the fluid in the torque converter which may lead to a stick-slip of the clutch plate(s).

The drive simulator used with the inventive method is a device that creates the effect/feelings of being in a moving vehicle. The movement is synchronous with a visual display and provides a tactile, or sense of touch, element to the drive simulation. The motion is synchronized to video and optionally audio signals, with the result being a combination of touch, sight and optionally sound. The drive simulator may be used to demonstrate the effect of inadequate lubrication of the transmission or axle resulting in driving events such as shudder, chatter and shift feel, as well as to simulate the driving of the vehicle when it is properly lubricated.

Referring to the drawings, drive simulator 100 includes support base 110, sled 120, seat 130, steering wheel 140, foot pedals 150, visual display unit 160, sled support bracket 170 which includes universal joint 175, and speakers 180. The simulator 100 has a front end 102, a back end 104, a left side 106 and a right side 108. A first motor 200 is mounted on the support base 110 and is operatively connected to the sled 120 through first gear box 202, first bell crank 204 and first pivot arm 206. Similarly, a second motor 210 is also mounted on support base 110 and is connected to the sled 120 through second gear box 212, second bell crank 214 and second pivot arm 216. Each of the gear boxes 202 and 212 contain a plurality of gears for stepping down the motor speed, for example, by a ratio of about 50:1. The various components of the drive simulator 100 may be made of any suitable material that provides the desired properties of strength, dimensional stability, and light weight. These materials may include steel, aluminum, plastic, fiberglass, and the like.

The operator of the drive simulator 100 may sit in the seat 130 and observe the visual images provided on the visual display unit 160. The operator may also hear sounds emitted by the speakers 180. The operator may control the movements of the drive simulator 100 by turning the steering wheel 140 to the right or left, and depressing or releasing the foot pedals 150. The sled 120 may move with two degrees of freedom relative to the support base 110. That is, the sled 110 may pitch forward towards the front end 102 and backwards towards the back end 104. The sled 120 may also roll to the left towards left side 106 and to the right towards right side 108. The degree of permissible pitch and roll may be in the range up to plus or minus about 20 degrees, and in one embodiment in the range up to plus or minus about 25 degrees. The sled 120 may pitch and roll at a velocity of up to about 24 inches (61 cm) per second, and in one embodiment up to about 20 inches (50.8 cm) per second. The sled 120 may pitch and roll at a rate of acceleration of up to about 5 g, and in one embodiment up to about 3 g. The term “g” is used herein to refer to acceleration due to gravity, i.e., 32.2 ft/sec² (980.7 cm/sec²).

The electrical system for operating the motors 200 and 210 includes power supply and circuit board box 218, circuit breaker box 220, power supply box 222, first adjustable frequency AC drive 224, resistor 226, second adjustable frequency AC drive 228, and resistor 230. The motors 200 and 210 may each be 110 volt or 230 volt alternating current (AC) motors. The power supply box 222 contains a first controller card or circuit board for operating motor 200. The power supply box 218 contains a second controller card or circuit board for controlling motor 210. The circuit boards translate data from the computer into signals for rotating or oscillating the motors 200 and 210. Resistor 226 is used to limit the current in the electrical system for motor 200. Similarly, resistor 230 is used to limit the current in the electrical system for the motor 210. The circuit breakers in the circuit breaker box 220 are used to protect the electrical system for the drive simulator 100 from current spikes. The speed of the motor 200 is controlled by the first adjustable frequency AC drive 224. The speed of the motor 210 is controlled by the second adjustable AC drive 228.

The foot pedals 150 may consist of two foot pedals, namely, a first foot pedal and a second foot pedal. The first foot pedal may be used to simulate the gas pedal of a vehicle. The first foot pedal is used to simulate acceleration which involves pitching the sled 120 backward. The second foot pedal may be used to simulate the braking of a vehicle and is used during braking. Braking is simulated when the sled 120 pitches forward.

The steering wheel 140 and foot pedals 150 are electronically connected through the first circuit board and the first adjustable frequency AC drive 224 to the first motor 200. The steering wheel 140 and foot pedals 150 are also electronically connected through the second circuit board and the second adjustable frequency AC drive 228 to the second motor 210.

The visual display unit 160 is used in combination with a computer (not shown in the drawings) for displaying graphic images generated by the computer. The visual display unit 160 may comprise a liquid crystal display (LCD) unit. The graphic images may be used to simulate a driving experience. For example, the graphic images may be in the form of a vehicle travelling along a race track as viewed from the interior of the vehicle, as shown in FIG. 7.

Acceleration may be simulated by pitching the sled 120 backward towards the back end 104. This may be accomplished by depressing the first foot pedal 150 to send an electrical signal to the first motor 200 causing it to rotate in a first direction and to the second motor 210 causing it to rotate in a second direction. The second direction is opposite the first direction. When viewed from the rear of the drive simulator 100, as shown in FIG. 5, the first direction may be clockwise (CW) and the second direction may be counter-clockwise (CCW). The rotation of the first motor 200 in the first direction causes the first bell crank 204 to rotate in the first direction and this in turn causes a lowering of the first pivot arm 206. The rotation of the second motor 210 in the second direction causes the second bell crank 214 to rotate in the second direction resulting in a lowering of the second pivot arm 216. The lowering of the first pivot arm 206 and the second pivot arm 216 causes a backward pitching of the sled 120. The image projected on the visual display unit 160 may be of a vehicle accelerating on a race track as viewed from the interior of the vehicle as shown in FIG. 7.

A simulated braking may be effected by pitching the sled 120 forward towards the front end 102. This may be accomplished by depressing the second foot pedal 150 to send an electrical signal to the first motor 200 causing it to rotate in the second direction and to the second motor 210 to rotate in the first direction. The rotation of the first motor 200 in the second direction causes a rotation of the first bell crank 202 in the second direction and a raising of the first pivot arm 206. The rotation of the second motor 210 in the first direction causes a rotation of the second bell crank 214 in the first direction and a raising of the second pivot arm 216. The raising of the first pivot arm 206 and the second pivot arm 216 causes a forward pitching of the sled 120 towards the front end 102.The image projected on the visual display unit 160 may be of a vehicle braking on a race track as viewed from the interior of the vehicle as shown in FIG. 7.

Turning to the right or to the left may be simulated. When a right turn is simulated, the sled 120 rolls to the left towards the left side 106. Similarly, when a left turn is simulated, the sled 120 rolls to the right towards the right side 108. The simulated left turn and consequent rolling of the sled 120 to the right is accomplished by turning the steering wheel 140 to the left. The turning of the steering wheel to the left transmits an electrical signal to the first motor 200 to rotate in the second direction and to the second motor 210 to also rotate in the second direction. The rotation of the first motor in the second direction causes a rotation of the first bell crank 204 in the second direction and a raising of the first pivot arm 206. The rotation of the second motor 210 in the second direction causes a rotation of the second bell crank 214 in the second direction and a lowering of the second pivot arm 216. The raising of the first pivot arm 206 and the lowering of the second pivot arm 216 causes a rolling of the sled 120 to the right. The image projected on the visual display unit 160 may be of a vehicle on a race track turning left as viewed from the interior of the vehicle as shown in FIG. 7.

The simulated right turn and consequent rolling of the sled 120 to the left may be accomplished by turning the steering wheel 140 to the right. This sends an electric signal to the first motor 200 to rotate in the first direction and to the second motor 210 to rotate in the first direction. The rotation of the first motor 200 in the first direction causes a rotation of the first bell crank 204 in the first direction and a lowering of the first pivot arm 206. The rotation of the second motor 210 in the first direction causes a rotation of the second bell crank 214 in the first direction and a raising of the second pivot arm 216. The lowering of the first pivot arm 206 and the raising of the second pivot arm 216 causes a rolling of the sled 120 to the left. The image projected on the visual display unit 160 may be of a vehicle on a race track turning right as viewed from the interior of the vehicle as shown in FIG. 7.

The drive simulator 100 may be used to simulate chatter or shudder by sending an electrical signal to the first motor 200 to oscillate in rotation from the first direction to the second direction and simultaneously to the second motor 210 to oscillate in rotation from the second direction to the first direction. This causes a pitching of the sled 120 backward and then forward. This is shown in FIG. 8 wherein data is sent from the computer to the first circuit board wherein it is translated into signals that are sent to the first adjustable frequency AC drive 224. The AC drive 224 electronically controls the movement of the first motor 200. Similarly, data is sent from the computer to the second circuit board wherein it is translated into signals that are sent to second adjustable frequency AC drive 228. The AC drive 228 electronically controls movement of the second motor 210. The oscillating movement of the motor 200 causes a clockwise (CW) then counter-clockwise (CCW) rotation of the first bell crank 204 and a consequent lowering and then raising of the first pivot arm 206. The simultaneous oscillating movement of the motor 210 causes a counter-clockwise and then clockwise rotation of the second bell crank 214 and a consequent lowering and then raising of the second pivot arm 216. This causes the sled 120 to pitch backward and then forward at a desired frequency. The backward and forward pitching results in vibration that may continue for any desired number of cycles, for example, 5 or 10 or more cycles.

Chatter may be simulated when the vehicle traveling along the race track shown on the visual display unit 160 is traveling at a simulated speed in the range from about 5 to about 30 miles per hour and the steering wheel 140 is turned to simulate a turn to the left or a turn to the right. Under these conditions, the computer sends data to the circuit boards to simulate chatter by oscillating the rotation of the first motor 200 and the second motor 210 at a frequency in the range from about 5 to about 10 cycles per second for a period of time in the range from about 1 to about 10 seconds. This causes the sled 120 to pitch backward and then forward. The backward and forward pitching results in vibration that may continue for any desired number of cycles, for example, 5 or 10 or more cycles. The operator sitting in the seat 130 can feel this vibration.

Shudder may be simulated by showing the vehicle in the visual display unit 160 travelling in first, second or third gear along the race track at a speed in the range from about 40 to about 90 miles per hour. Under these conditions, shudder is simulated by oscillating the rotation of the first motor 200 and the second motor 210 at a frequency in the range from about 5 to about 10 cycles per second for a period of time in the range from about 1 to about 10 seconds. This causes the sled 120 to pitch backward and then forward. The backward and forward pitching results in vibration that may continue for any desired number of cycles, for example, 5 or 10 or more cycles. The operator sitting in the seat 130 can feel this vibration.

The drive simulator 100 may be used to simulate shift feel by sending a signal to the first motor 200 to rotate in the second direction and simultaneously to the second motor 210 to rotate in the first direction for a period of time in the range from about 0.1 to about 0.3 seconds, and then to rotate the first motor 200 in the first direction and simultaneously rotate the second motor 210 in the second direction for a period of time in the range from about 0.1 to about 0.3 seconds. This causes a pitching of the sled 120 forward and then backward. This is shown in FIG. 9 wherein data is sent from the computer to the first circuit board which translates the data into electrical signals that are sent to the first adjustable frequency AC drive 224. The AC drive 224 electronically controls the movement of the first motor 200. Similarly, data is sent from the computer to the second circuit board which translates the data into signals that are sent to second adjustable frequency AC drive 228. The AC drive 228 electronically controls movement of the second motor 210. The movements of the motor 200 causes a counter-clockwise and then clockwise rotation of the first bell crank 204 and a consequent raising and then lowering of the first pivot arm 206. The movements of the motor 210 causes a clockwise and then counter-clockwise rotation of the second bell crank 214 and a consequent raising and then lowering second pivot arm 216. This causes the sled 120 to pitch forward and then backward at a desired frequency. When simulating shift feel the visual display unit 160 indicates that the vehicle is in motion and is upshifting gears. The sled 120 may pitch forward about 0.1 to about 5 degrees, and in one embodiment from about 1 to about 5 degrees, for a period of time in the range from about 0.1 to about 0.3 seconds, and then pitch backward about 0.1 to about 5 degrees, and in one embodiment from about 1 to about 5 degrees, for a period of time in the range from about 0.1 to about 0.3 seconds. The pitching forward and backward can be felt as a bump by the operator sitting in the seat 130.

The one or more speakers 180 may be used to provide sound effects corresponding to the drive experience provided by the drive simulator 100. For example, when demonstrating chatter, the computer may send a signal to the speakers 180 to provide a whining/moaning noise.

The software used to operate the drive simulator 100 may be any software that can provide for the movement of the sled 120 with two degrees of freedom and for displaying the desired images on the visual display unit 160. The images may be in the form of a simulated vehicle travelling along a race track taken from the perspective of a driver in the vehicle as illustrated in FIG. 7. The software may be modified to provide for the chatter, shudder and shift feel events. Any software that can provide for the rotating and oscillating movements for the motors 200 and 210 described above may be used. Any personal computer suitable for handling the foregoing software may be used.

The drive simulator 100 as well as the interface software providing for the movement of the sled 120 may be obtained from InMotion Simulation, LLC of Prescott Valley, Ariz.

The software providing for the images on the visual display unit 160 may be obtained from Image Space Incorporated of Ann Arbor, Mich.

The drive simulator 100 may be used as a diagnostic tool. This may involve a method comprising: driving a test vehicle to experience vibration and/or bumping resulting from chatter, shudder or shift feel; (B) operating the drive simulator 100 to experience vibration and/or bumping comparable to the vibration and/or bumping experienced in the test vehicle; (C) determining whether the vibration and/or bumping experienced in the test vehicle is from chatter, shudder or shift feel based on a comparison of the results from steps (A) and (B); and (D) lubricating the test vehicle to correct for chatter, shudder or shift feel. When the problem in the test vehicle is determined to relate to shudder, the problem may be corrected by employing an automatic transmission fluid (ATF) with anti-shudder properties. When the problem in the test vehicle is determined to relate to chatter, the problem may be corrected by employing a lubricant for the rear axle with anti-chatter properties. When the problem in the test vehicle is determined to relate to shift feel, the problem may be corrected by employing an ATF with enhanced properties for correcting for shift feel.

While the disclosed invention has been explained in relation to various detailed embodiments, it is to be understood that various modifications thereof may become apparent to those skilled in the art upon reading the specification. Therefore, it is to be understood that the invention specified herein is intended to include such modifications as may fall within the scope of the appended claims.

1. A method of operating a drive simulator, the drive simulator comprising: a sled mounted on a support base, the sled being capable of pitching forward and backward and rolling left and right; a first motor mounted on the support base and connected to the sled; a second motor mounted on the support base and connected to the sled; a steering wheel; a first foot pedal; a second pedal; a computer and a visual display unit for displaying images generated by the computer, the images providing a simulated driving experience; the steering wheel, first foot pedal and second foot pedal being electronically connected to the first motor and to the second motor and adapted for controlling the images, the method comprising:
depressing the first foot pedal, the depressing of the first foot pedal causing the first motor to rotate in a first direction and the second motor to rotate in a second direction, the second direction being opposite the first direction, the rotation of the first motor in the first direction and the rotation of the second motor in the second direction causing backward pitching of the sled, and the depressing of the first foot pedal causing the image of an accelerating vehicle to appear on the visual display unit;
depressing the second foot pedal, the depressing of the second foot pedal causing the first motor to rotate in the second direction and the second motor to rotate on the first direction, the rotation of the first motor in the second direction and the rotation of the second motor in the first direction causing a forward pitching of the sled, and the depressing of the second foot pedal causing the image of a braking vehicle to appear on the visual display unit;
turning the steering wheel to the left, the turning of the steering wheel causing the first motor to rotate in the second direction and the second motor to rotate in the second direction, the rotation of the first motor in the second direction and the rotation of the second motor in the second direction causing a rolling of the sled to the right, and the turning of the steering wheel causing the image of a vehicle turning left to appear on the visual display unit;
turning the steering wheel to the right, the turning of the steering wheel causing the first motor to rotate in the first direction and the second motor to rotate in the first direction, the rotation of the first motor in the first direction and the rotation of the second motor in the first direction causing a rolling of the sled to the left, and the turning of the steering wheel causing the image of a vehicle turning right to appear on the visual display unit;
simulating chatter by turning the steering wheel to the left or right causing the sled to roll to the right or to the left, and transmitting an electronic signal to the first motor to oscillate the rotation of the first motor from the first direction to the second direction and transmitting an electronic signal to the second motor to oscillate the rotation of the second motor from the second direction to the first direction to cause the sled to pitch backward and then forward;
simulating shudder by transmitting an electronic signal to the first motor to oscillate the rotation of the first motor from the first direction to the second direction and transmitting an electronic signal to the second motor to oscillate the rotation of the second motor from the second direction to the first direction to cause the sled to pitch backward and then forward; and
simulating shift feel by transmitting an electronic signal to the first motor to rotate the first motor in the second direction and rotate the second motor in the first direction to cause the sled to pitch forward, then to rotate the first motor in the first direction and rotate the second motor in the second direction to cause the sled to pitch backward.

2. The method of claim 1 wherein the first motor is connected to the sled through a first gear box, a first bell crank and a first pivot arm, the first gear box comprising a plurality of gears; and the second motor is connected to the sled through a second bell crank and a second pivot arm, the second gear box comprising a plurality of gears;
the rotation of the first motor in the first direction causing the gears in the first gear box and the first bell crank to rotate in the first direction and a lowering of the first pivot arm, the rotation of the second motor in the second direction causing the gears in the second gear box and the second bell crank to rotate in the second direction and a lowering of the second pivot arm, the lowering of the first pivot arm and the second pivot arm causing backward pitching of the sled;
the rotation of the first motor in the second direction causing the gears in the first gear box and the first bell crank to rotate in the second direction and a raising of the first pivot arm, the rotation of the second motor in the first direction causing the gears in the second gear box and the second bell crank to rotate in the first direction and a raising of the second pivot arm, the raising of the first pivot arm and the second pivot arm causing a forward pitching of the sled;
the sled rolling to the right by rotating the first motor in the second direction and rotating the second motor in the second direction, the rotation of the first motor in the second direction causing the gears in the first gear box and the first bell crank to rotate in the second direction and a raising of the first pivot arm, the rotation of the second motor in the second direction causing the gears in the second motor and the second bell crank to rotate in the second direction and a lowering of the second pivot arm, the raising of the first pivot arm and the lowering of the second pivot arm causing a rolling of the sled to the right; and
the sled rolling to the left by rotating the first motor in the first direction and the second motor in the first direction, the rotation of the first motor in the first direction causing the gears in the first gear box and the first bell crank to rotate in the first direction and a lowering of the first pivot arm, the rotation of the second motor in the first direction causing the gears in the second motor and the second bell crank to rotate in the first direction and a raising of the second pivot arm, the lowering of the first pivot arm and the raising of the second pivot arm causing a rolling of the sled to the left.

3. The method of claim 1 wherein the transmitting of the signal to oscillate the rotation of the first motor and the second motor to simulate chatter or shudder is initiated by the computer.

4. The method of claim 1 wherein the transmitting of the signal to rotate the first motor and the second motor to simulate shift feel is initiated by the computer.

5. The method of claim 1 wherein the steering wheel is turned to the right or the left and the image on the visual display unit is of a vehicle travelling at a speed in the range from about 5 to about 30 miles per hour, the computer sending a signal to simulate chatter by oscillating the rotation of the first motor and the rotation of the second motor at a frequency in the range from about 5 to about 10 cycles per second for a period of time in the range from about 1 to about 10 seconds.

6. The method of claim 1 wherein the image on the visual display unit is of a vehicle traveling in first, second or third gear at a speed in the range from about 40 to about 90 miles per hour, the computer sending a signal to simulate shudder by oscillating the rotation of the first motor and the rotation of the second at a frequency in the range from about 5 to about 10 cycles per second for a period of time in the range from about 1 to about 10 seconds.

7. The method of claim 1 wherein the image on the visual display unit is of a vehicle in motion and upshifting to any gear, the computer sending a signal to simulate shift feel by rotating the first motor and the second motor to pitch the sled forward for a period of time in the range from about 0.1 to about 0.3 seconds and then to pitch the sled backward for a period of time in the range from about 0.1 to about 0.3 seconds.

8. The method of claim 1 wherein the drive simulator further comprises one or more speakers, the one or more speakers providing sound effects corresponding to the simulated driving experience, the sound effects being initiated by the computer.

9. A diagnostic method, comprising:
(A) driving a test vehicle to experience vibration and/or bumping resulting from chatter, shudder or shift feel;
(B) conducting the method of any of the foregoing claims to experience vibration and/or bumping in the drive simulator comparable to the vibration and/or bumping experienced in the test vehicle;
(C) determining whether the vibration and/or bumping experienced in the test vehicle is from chatter, shudder or shift feel based on a comparison of the results from steps (A) and (B); and
(D) lubricating the test vehicle to correct for chatter, shudder or shift feel.
